(19) United States
(12) Patent Application Publication
(10) Pub. No.: US 2007/0053108 A1
(43) Pub. Date: Mar. 8, 2007

(54) Glide head for magnetic disk

(76) Inventors: Takeshi Sato, Utsunomiya (JP); Susumu Matsui, Mohka (JP); Shinji Furuichi, Mohka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/574,690

(22) PCT Filed: Aug. 11, 2005
(86) PCT No.: PCT/JP05/14742

§ 371 Date: Apr. 5, 2006

(30) Foreign Application Priority Data
Sep. 9, 2004 (JP) 2004-261947
Sep. 17, 2004 (JP) 2004-270969

(51) Int. Cl. G11B 5/48

(52) U.S. Cl. 360/240

(57) ABSTRACT

Disclosed is a glide head for a magnetic disk that has a high sensitivity for efficiently transmitting a vibration due to a defect of a magnetic disk to piezoelectric element and the like and has high abrasion resistance and a long service life. The glide head is resiliently held at an end of a suspension arm through a flexure and has a slider, a load point of which a pressing force from the suspension arm is applied to through a pivot disposed on the flexure. The slider comprises two sliding rails that protrude from a bottom surface of the slider, extend from a leading end of the slider to a trailing end of the slider, parallel to and at a distance from each other, and have near the trailing end of the slider a rear edge that works as a sensor for detecting the defect of the magnetic disk. Each sliding rail has an upstream floating surface positioned within a region from the slider leading end to the load point and a downstream floating surface within a region from the load point to the slider trailing end so that the slider has a floating pitch angle from 140 to 380 μrad. A length of the upstream floating surface is preferably from 0.67 to 0.91 as expressed by a ratio to the total floating surface length.

### TECHNICAL FIELD

The present invention relates to a glide head for use in an inspection and the like in manufacture of a magnetic disk.

### BACKGROUND ART

A magnetic disk used for a hard disk drive is made of a disk-like non-magnetic substrate such as glass or aluminum. A magnetic film and a protective film mainly made of carbon are formed on the surface of the non-magnetic substrate and fluorocarbon lubricant is applied to the protective film. The magnetic disk thus formed is combined with a magnetic head and used as a recorder for recording or reproducing information. A glide head for a magnetic disk (hereinafter sometimes also simply referred to as glide head) is used in an inspection process for the magnetic disk as a sensor for detecting a minute projection, foreign matter and the like (hereinafter referred to as defect) formed on the surface of the magnetic disk. Several types of the glide head are practically used. However, a glide head mounting a piezoelectric element or an AE (Acoustic Emission) sensor at the outside of the head are mainly used. A piezoelectric element type glide head and an AE type glide head are different only in a mode for converting vibration caused, when the slider of a glide head collides with a minute defect formed on the surface of a magnetic disk, into a voltage. Therefore, in this specification, a glide head is described, referring to the piezoelectric element mode.

A glide head mounting a piezoelectric element on a slider is disclosed in Patent Document 1. FIG. 15 depicts a perspective view of the glide head disclosed in Patent Document 1 mounting the piezoelectric element on the slider. A slider 10 has a pair of sliding rails 30. A protruded portion 12 is formed on a side of the slider 10 and a piezoelectric element 40 is mounted on the back of the slider at the protruded portion 12. An output voltage of the piezoelectric element 40 is fetched out from both ends in the polarized direction of the crystal constituting the piezoelectric element through lead wires 42 and taken out to the outside through an insulating tube 52 fixed to a suspension arm 50. Hereinafter, the same reference numerals are used for the same component and the same portion in order to make description understandable.

The operation principle of a glide head is briefly described below, referring to FIG. 16. A flexure 60 provided for a suspension arm 50 is set to the back of a slider 10. A top of a pivot 65 formed on the flexure 60 is pressed against the back of the slider and, in turn, the slider is pressed against a magnetic disk 70 by applying a load to the slider 10 from the suspension arm 50. The slider 10 can slightly vertically and horizontally move around the pivot 65 as a fulcrum. The position for the pivot 65 to apply a load to the slider becomes a load point. In FIG. 16, a piezoelectric element, lead wire and the like are omitted. The slider 10 is floated due to the action of an air flow (shown by an arrow in FIG. 16) according to the rotation of the magnetic disk 70. Air flows from the leading end to the trailing end of the slider. The flying height h of the glide head depends on various factors, but it is mainly decided by the flow rate of air, the sliding rail width of the slider and the load to the slider. Because the rail width and the load are fixed by the structure of the glide head, the flying height of the glide head is decided by the linear speed decided by the number of revolutions of the magnetic disk 70 and glide head position (radius position on the magnetic disk) on the magnetic disk. By changing the speed of revolutions of the magnetic disk in accordance with the radius position of the glide head on the magnetic disk so that the linear speed becomes constant on a whole magnetic disk surface, the glide head can be floated with a constant flying height h from the magnetic disk 70.

In general, in a glide head, a linear speed is kept constant on a whole magnetic disk surface in order to keep a gliding condition constant on the whole magnetic disk surface, that is, a flying height h constant on the whole magnetic disk surface and uniform the energy caused when a defect collides with the glide head, maintaining constant the relative speed between the defect and the glide head. Moreover, to keep constant the flying height or attitude at the time of floating on the whole magnetic disk surface, the advance direction (YAW angle) of the slider of the glide head is kept constant to the tangent line of a circle on the magnetic disk on which the slider flies at any radius position on the magnetic disk, and a glide height test is normally performed at 0°. When the slider 10 contacts or collides with a defect 72 on the magnetic disk 70, vibration caused due to the collision travels the slider 10 to vibrate and deform the piezoelectric element 40. Electric charge is induced on electrodes of the piezoelectric element 40, an inter-electrode voltage is output through the lead wires 42, and the defect 72 can be detected. When the slider 10 having a predetermined flying height h moves on the surface of the magnetic disk, the slider 10 contacts or collides with a defect 72 higher than the flying height h. By knowing the output voltage of the piezoelectric element caused and a radius position on the magnetic disk, a defect out of allowance can be detected on the surface of the magnetic disk.

For a glide head to be operated according to the principle, two sliding rails for generating buoyancy is generally formed to protrude on both sides of an air inflow groove. Because of the two sliding rails used, the attitude of the slider can be kept stable during floating.

Recent trends of a magnetic disk drive to high capacity and small size, that is, change of a magnetic disk drive to high recording density has been progressed at a blistering pace. To raise a recording density, the width and length of a recording bit have been decreased more and more, and change of a magnetic head to small track width and change of a magnetic gap to small gap have been progressed accordingly. Moreover, because a magnetic head is moved at a high speed in the radius direction of a magnetic disk, a magnetic head slider is downsized. To raise the recording density, it is required to obtain a gap of b 12 nm or less between a magnetic disk and a magnetic head, that is, the flying height h of a magnetic head slider.

When a magnetic head floats on a magnetic disk to record or reproduce information, if there is a defect higher than the flying height of a slider of the magnetic head on the surface of the magnetic disk, the slider collides with the magnetic disk and information cannot be accurately recorded or reproduced. Moreover, the defect may cause damage of data or breakdown of a magnetic disk drive. Therefore, it is necessary to make a defect on a surface of a magnetic disk lower than the flying height of the slider of a magnetic head. When the flying height of the slider is minimized, a height allowed for a defect on the magnetic disk tends to lower and lower. The height requirement of the defect becomes 9 nm or less.

The flying height of a glide head can be reduced by decreasing the sliding rail width of a slider or increase a load when the same linear speed is maintained. When increasing the load, a required time is increased for the slider taking off from the surface of a magnetic disk and a hazard of damaging the magnetic disk may increase. Therefore, this is not very desirable. Moreover, when increasing the load without changing a position of a load point, the pitch angle of the slider decreases. Therefore, this is not desirable because the sensitivity of the glide head would be deteriorated. To decrease the flying height without changing a position of the load, it is effective to decrease the width of a rail that generates a floating force. However, when decreasing the rail width and decreasing the flying height, the width of a portion for detecting a defect is narrowed because a rear edge of the rail for deciding the flying height h also serves as a defect detecting portion. To inspect a whole surface of a magnetic disk, there is a problem that a longer time is required for inspection because of stopping a glide head at a certain radius position on a magnetic disk to inspect and then moving the glide head at least with the rail width interval in a radius direction of the magnetic disk, whenever performing inspection and repeating the above operations. The moving width of the glide head in the radius direction of the magnetic disk is generally smaller than the defect detecting rail width of the glide head, and defect detection is repeatedly performed several times at the same radius position on the magnetic disk by the rail to improve the accuracy of defect detection. Therefore, when decreasing the rail width, the inspection time becomes longer, and the cost required for inspection is increased.

To certainly detect a low defect on a magnetic disk, a high-sensitivity glide head sensitive for collision with defects is required. When the height of a defect to be detected is small, the volume of the defect is generally also decreased and the vibration caused by the collision between the defect and the glide head slider reduces. To raise the sensitivity for detecting a defect by the glide head, it is necessary to raise the efficiency for converting the force into vibration of the slider at the time of collision between the defect and the glide head slider.

As a magnetic disk drive is used not only for computers but also for wide fields such as video recording of a television and a copying machine, demands for increase of numerical quantity and decrease of price have become strong. To satisfy these demands, change of an inspection process to high efficiency is required in addition to manufacturing technologies, study of manufacturing steps and the like of a magnetic disk itself. In the glide height inspection that is one of the inspection steps, prolongation of service life of a glide head to be used for the glide height inspection is the most important. By prolonging the service life of the glide head, that is, by increasing the number of magnetic disks that can be inspected by a single glide head, the number of glide heads to be used can be reduced. It takes a long time to replace a glide head of a glide height inspection machine, and the inspection of magnetic disks cannot be made during the replacement period. The operating time of the inspection machine can be increased by prolonging the service life of a glide head, resulting in decreasing the consumption number of glide heads and decreasing the replacement frequency of glide heads, and the manufacturing cost of a magnetic disk can be decreased and the production number of magnetic disks can be increased.

The service life of a glide head can be evaluated with the value of an output voltage from a glide head. Before using a glide head for inspection of magnetic disks, an output voltage V0 is measured by using a bump disk having a reference defect height. After inspecting a predetermined number of magnetic disks, an output voltage of the glide head measured by using the same bump disk in order to confirm a measurement accuracy is presumed to be V1. For example, when V1 is almost equal to V0, it can be judged that the glide head can be still used and that inspected magnetic disks were properly inspected. When V1 lowers up to 60% of V0, it is judged that the service life of the glide head expires but that magnetic disks having been inspected were properly inspected. When V1 lowers to 30% of V0, not only the glide head should be replaced but also magnetic disks inspected should be re-inspected with a judgment that a trouble must have occurred in the glide head. The judgment on the value of V1 and on whether to carry out re-inspection is made by a user of the glide head. Alternatively, a service life can be judged with the value of V1 instead of the ratio of V1 to V0.

As causes of output deterioration of the glide head, deterioration of the piezoelectric element itself and decrease of a flying height due to abrasion of a slider may be considered. As a result of examining a number of glide heads that had been replaced because of expiration of their service lives, it has been found that the cause overwhelmingly lies in change of flying heights due to abrasion of the slider. Thus, to obtain a glide head having a long service life, it is necessary to obtain a glide head having a high abrasion resistance.

Patent Document 1: Japanese Laid-Open Patent 11-16163

### DISCLOSURE OF THE INVENTION

### Problems to be Solved by the Invention

An object of the present invention is to provide a glide head for a magnetic disk having such a high sensitivity that a vibration caused by a collision of the glide head with a magnetic disk defect is efficiently transmitted to a piezoelectric element and having a high abrasion resistance and a long service life.

### Means for Solving the Problems

A glide head for a magnetic disk according to the present invention, comprises: a suspension arm and a slider, whose back is resiliently held to an end of the suspension arm through a flexure and has a load point to which a pressing force from the suspension arm is applied through a pivot disposed on the flexure. The slider comprises, on a bottom surface of the slider opposed to the back, two sliding rails protruding from the bottom surface, extending from a leading end of the slider to a trailing end of the slider, in parallel and at a distance from each other, and having, near the trailing end of the slider, a rear edge that works as a sensor for encountering a defect on a magnetic disk; a transducer for transforming a mechanical energy caused due to the defect to an electric signal mounted on the back; and the load point positioned substantially on a center line between the two sliding rails on the back. Each sliding rail has an upstream floating surface positioned within a region from the slider leading end to the load point and a downstream floating surface positioned within a region from the load point to the slider trailing end on a floating surface of the sliding rail so that the slider has a floating pitch angle from 140 to 380 μrad.

In the glide head for a magnetic disk set forth above, a length of the upstream floating surface of each of the sliding rails is preferably from 0.67 to 0.91 as expressed by a ratio to the sum of the length of the upstream floating surface plus a length of the downstream floating surface. It is more preferable that the ratio is from 0.75 to 0.85.

In the glide head for a magnetic disk described above, the upstream floating surface of the sliding rail may continue to the downstream floating surface. Alternatively, the two sliding rails may be divided into the upstream floating surface and the downstream floating surface by a traversing groove disposed on the sliding rails.

In the glide head for a magnetic disk according to the present invention, the upstream floating surface may have a tapered surface having an angle from 0.3 to 1.0 degrees with respect to the floating surface at the leading end. Alternatively, the upstream floating surface may have a flat floating surface at the leading end.

In the glide head for a magnetic disk, it is preferable that the downstream floating surface is widening in a direction of the rear edge of the sliding rail, and that the total width of the two sliding rails at the rear edges is equal to or more than a half of a distance between outside surfaces of the two sliding rails.

In the glide head for a magnetic disk according to the present invention, it is desirable that the floating pitch angle of 140 to 380 μrad. can be accomplished under conditions that: a relative linear speed of the glide head with the magnetic disk is 8 to 16 m/sec.; a flying height of the glide head is 1 to 15 nm; and the pressing force of the suspension arm is 9.8 to 58.8 mN.

### Advanatges of the Invention

The glide head of the present invention can have a floating pitch angle from 140 to 380 μrad. The glide head having a floating pitch angle of 140 μrad. or more delivers an output voltage due to a magnetic disk defect that is more than about twice in comparison with an output voltage from a conventional glide head having a floating pitch angle of 80 μrad. Furthermore, a larger output voltage can be obtained even by a defect as small as a defect less than 1 μm diameter, and the glide head is more sensitive than a conventional one.

When a service life of a glide head is expressed by a number of magnetic disks that have been inspected, until a replacement of the glide head is required, a glide head according to the present invention can inspect magnetic disk number of at least 1.2 times to twice, comparing to a conventional glide head having the floating pitch angle of 80 μrad., resulting in a long service life glide head.

### BRIEF DESCRIPTION OF DRAWINGS

FIG. 1 is a perspective view, when observed from a bottom, showing a glide head of EXAMPLE 1 according to the present invention;

FIG. 2 is a bottom plan view showing a glide head of EXAMPLE 1 according to the present invention;

FIG. 3 is explanatory drawings for explaining a force F caused by a defect and working on a slider of a glide head and a distance L for a conventional glide head (FIG. 3A) and a glide head of the present invention (FIG. 3B);

FIG. 4 is a graph showing a relationship of a floating pitch angle (μrad.) of the glide head of EXAMPLE 1 with a ratio of an upstream floating surface length to a total floating surface length;

FIG. 5 is a graph showing a relationship of an output voltage (V) of the glide head of EXAMPLE 1 with the floating pitch angle (μrad.) and also showing a range from maximum output voltage to minimum output voltage for each floating pitch angle;

FIG. 6 is a graph showing a relationship of an output voltage (V) of the glide head of EXAMPLE 1 with a defect diameter for floating pitch angles as a parameter;

FIG. 7 is a graph showing a relationship of inspected magnetic disk numbers until glide head replacement is required, with a floating pitch angle (μrad.) for the glide head of EXAMPLE 1;

FIG. 8 is a perspective view, when observed from a bottom, showing a glide head of EXAMPLE 2 according to the present invention;

FIG. 9 is a bottom plan view showing the glide head of EXAMPLE 2 according to the present invention;

FIG. 10 is a graph showing a relationship of a floating pitch angle (μrad.) with a ratio of an upstream floating surface length to a total floating surface length for the glide head of EXAMPLE 2;

FIG. 11 is a graph showing a relationship of an output voltage (V) with a floating pitch angle (μrad.) for the glide head of EXAMPLE 2;

FIG. 12A is a bottom plan view of a glide head of EXAMPLE 3 according to the present invention; FIG. 12B is a bottom plan view of a glide head having another structure of EXAMPLE 3 according to the present invention; FIG. 12C is a bottom plan view of a glide head having still another structure of EXAMPLE 3 according to the present invention; FIG. 12D is a bottom plan view of a glide head having further another structure of EXAMPLE 3 according to the present invention; and FIG. 12E is a bottom plan view of a glide head having still further another structure of EXAMPLE 3 according to the present invention;

FIG. 13 shows a glide head of EXAMPLE 4 according to the present invention with a perspective view observed from a bottom;

FIG. 14 shows a glide head of EXAMPLE 5 according to the present invention with a perspective view observed from a bottom;

FIG. 15 is a perspective view of a glide head disclosed in a prior document; and

FIG. 16 is an explanatory drawing for explaining a function of a glide head.

### EXPLANATION OF REFERENCE NUMERALS

10 slider

14 leading end of a slider

16 trailing end of a slider

30, 30′, 30″ sliding rail

32, 32′ upstream floating surface

34, 34′ downstream floating surface

34e, 34e′ rear edge

36, 36a, 36b, 36c, 36d, 36e groove

40 transducer (piezoelectric element)

50 suspension arm

67 load point

321, 321′ tapered surface

### BEST MODE FOR CARRYING OUT OF THE INVENTION

A glide head of the present invention is described in detail about EXAMPLES, referring to the accompanying drawings. The same components and same portions are provided with the same reference numerals.

### EXAMPLE 1

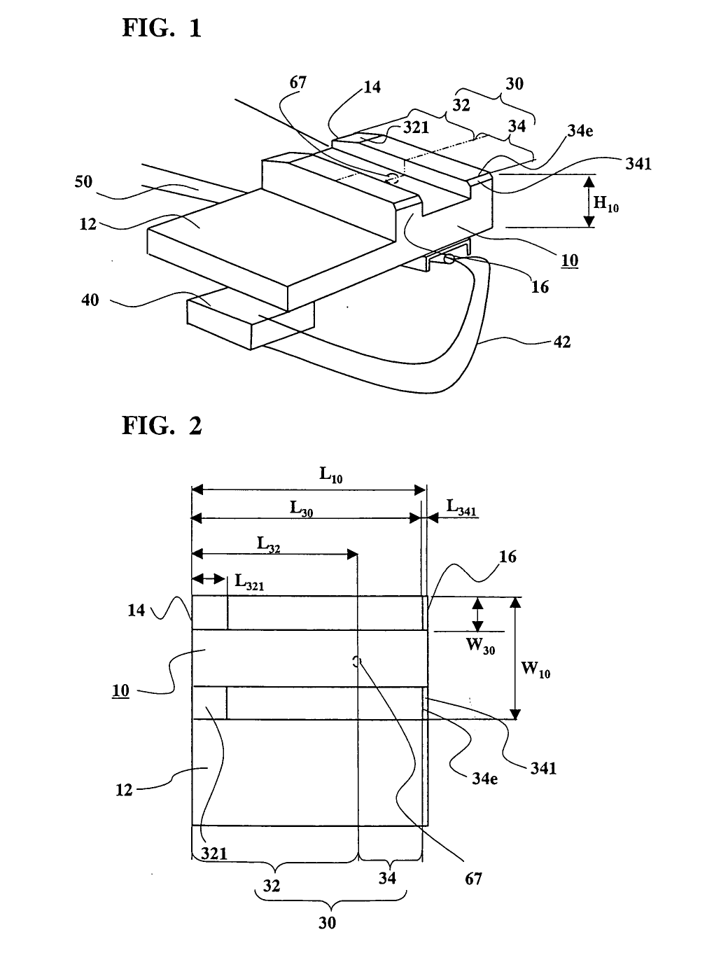

The glide head of EXAMPLE 1 of the present invention is shown in a perspective view of FIG. 1, observed from a bottom, and a bottom plan view of FIG. 2. The glide head is constituted of a slider 10 and a suspension arm 50, a back of the slider 10 is resiliently held to a front end of the suspension arm 50 through a flexure, and a pressing force is applied to a load point on the back from the suspension arm 50 through a pivot set to the flexure. Because a structure of the flexure and a structure in which the slider is set to the suspension arm through the flexure are the same as those of a convention glide head, they are not illustrated. The slider 10 has two sliding rails 30 on a bottom surface (may be also referred to as an air bearing surface) opposite to the back, which protrude from the bottom surface and extend in parallel and at a distance from each other from a slider leading end 14 to a slider trailing end 16. The load point, at which the pressing force from the suspension arm 50 is applied to the slider 10 by the pivot fixed to the flexure, is on the back of the slider. A point on the bottom surface of the slider corresponding to the load point is referred to as “load point” 67 for convenience' sake of description. It is preferable that the load point 67 is substantially located on a center line between the two sliding rails 30. Though it is the most preferable that the load point 67 is located on the center line between the two sliding rails 30, the load point 67 may be at a position deviated to left or right 1/10 or less of the slider width (distance between outsides of two sliding rails) from the center line. When the load point 67 is at a position deviated 1/10 or less of the slider width from the center line, the roll angle of the glide head can be maintained within ±10 μrad. Each sliding rail 30 has a rear edge 34e serving as a sensor for encountering a defect on a magnetic disk near the slider trailing end 16. The slider 10 has a transducer 40 serving as a piezoelectric element set to the back of the slider 10. When the rear edges 34e of the sliding rails encounter a defect on a magnetic disk, it converts mechanical energy generated by the defect into an electrical signal and detects the defect. In the glide head shown in FIGS. 1 and 2, the slider 10 has a protruded portion 12 on a side, and the transducer 40 is mounted on the back of the protruded portion 12.

In this EXAMPLE, the slider 10 is made of alumina titanium carbide (Al₂O₃—TiC) and it has a length L₁₀ of 1.25 mm, width W₁₀ of 1.0 mm, and height H₁₀ of 0.4 mm. Two sliding rails 30 respectively have a length L₃₀ of 1.22 mm and rail width W₃₀ of 0.165 mm. Chamfering is applied to each of the sliding rails 30 at the slider trailing end 16 and a chamfering length L₃₄₁ is 0.03 mm.

A bottom surface of each of the sliding rails 30 works as a floating surface. Floating surfaces of the right and left sliding rails 30 are substantially on a level with each other, and buoyancy is generated by an air flow incoming when the glide head runs at a certain linear speed relatively to a magnetic disk. Floating surfaces of the sliding rails 30 respectively have a tapered surface having an angle of 0.3 to 1.0° from the floating surfaces at their leading ends. When floating of the glide head is started from the magnetic disk, lifting power increases. In the EXAMPLE, the length L₃₂₁ of the tapered surface 321 is 0.2 mm.

The floating surface of each sliding rail is constituted of an upstream floating surface 32 positioned within a region from the slider leading end 14 to the load point 67 and a downstream floating surface 34 positioned within a region from the load point 67 to the slider trailing end 16. The upstream floating surface 32 includes the tapered surface 321 having a small angle (0.3 to 1.0°). However, because a chamfering portion 341 at the rear edge of the rail has a large angle of approx. 20° and hardly has lifting power, the portion 341 is not included in the downstream floating surface 34. Because the load point 67 is located at a distance of 0.98 mm from the slider leading end, the length L₃₂ of the upstream floating surface 32 is 0.98 mm, and the length of the downstream floating surface 34 is 0.24 mm. A lifting force works on the whole floating surface, but a larger lifting force out of the whole lifting force works on the upper floating surface 32 on the side of the slider leading end 14 with respect to the load point 67 so that the slider leading end 14 becomes higher than the slider trailing end 16 and a floating pitch angle is caused. In the glide head of this EXAMPLE, the ratio of the length L₃₂ of the upstream floating surface 32 to the total length L₃₀ of the floating surface was approx. 0.80. When rotating a magnetic disk at a linear speed of 10 m/sec to the glide head by assuming that the force (load or pressing force) for the suspension arm 50 to press the slider 10 down was 37 mN, the flying height of the glide head was approx. 10 nm in a height of the rear edge of the sliding rail of the glide head and the floating pitch angle was approx. 270 μrad. The floating pitch angle was approx. 380 μrad. when setting the pressing force to 20 mN and the linear speed to 15 m/sec.

The floating pitch angle is twice to four times larger than a floating pitch angle of 80 to 100 μrad. for a conventional glide head. Therefore, the glide head is greatly improved in sensitivity and a service life as described below.

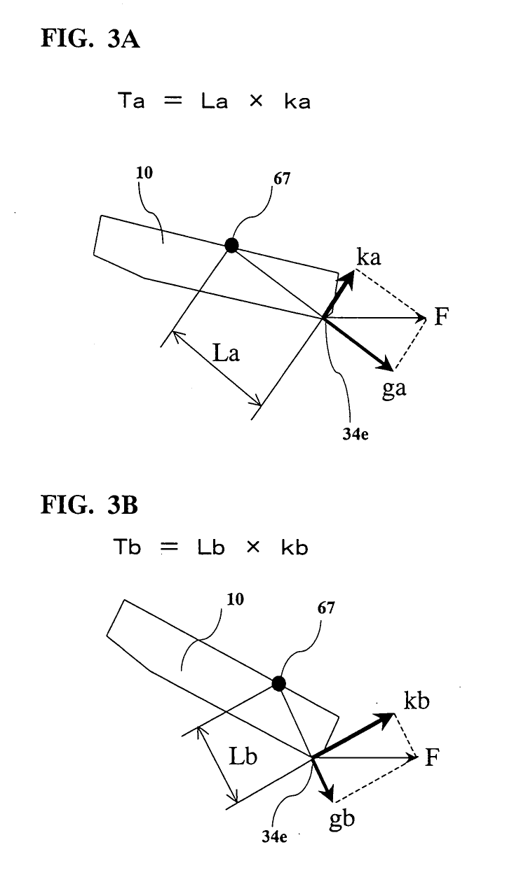

The glide head vibrates around the load point as a fulcrum. The magnitude of vibration caused due to collision between the defect of the magnetic disk and the rear edge of the sliding rail of the glide head can be considered to be caused by a rotation torque T which is a product of the distance L from the load point to the sliding-rail rear edge for detecting a defect and the force F caused by the defect. Illustrations of the force F working on the slider 10 of the glide head and generated by a defect and the distance L are shown in FIGS. 3A and 3B on a conventional glide head and a glide head of the present invention, respectively. Because the floating pitch angle of a glide head of the present invention is larger than a conventional floating pitch angle, an angle from the horizontal line of the slider in FIG. 3B is shown as a larger value and an angle from the horizontal line of the slider in FIG. 3A is shown as a smaller value. In FIG. 3A, when assuming the distance from the load point 67 to the sliding-rail rear edge 34e as La and the force due to a defect as F, the force F can be divided into a vertical component ka vertical to the La and an La directional component ga. Vibration of the slider is generated by a torque Ta=La×ka. The La directional component ga of the force F is a force when the sliding-rail rear edge and a defect are scraped each other. In FIG. 3B, when assuming the distance from the load point 67 to the sliding-rail rear edge 34e as Lb and the force due to a defect as F, the force F can be divided into a component kb vertical to the Lb and an Lb directional component gb. The torque for generating vibration of the slider is Th=Lb×kb, and kb is larger than ka. Therefore, when the distance La is equal to the distance Lb, Th is larger than Ta also for the torque for vibrating the slider. When the floating pitch angle becomes from twice to four times, the torque is increased by 20% to 50%. Therefore, in the glide head of the present invention, an output voltage becomes higher than a conventional one. As a result of comparing components ga and gb of the force F, ga is larger than gb. Therefore, a glide head of the present invention is expected to have a service life longer than that of a conventional glide head. By preparing glide heads having various floating pitch angles, influences of floating pitch angles on output voltages of the glide heads and service lives are studied below.

Influence of Position of Load Point on Floating Pitch Angle

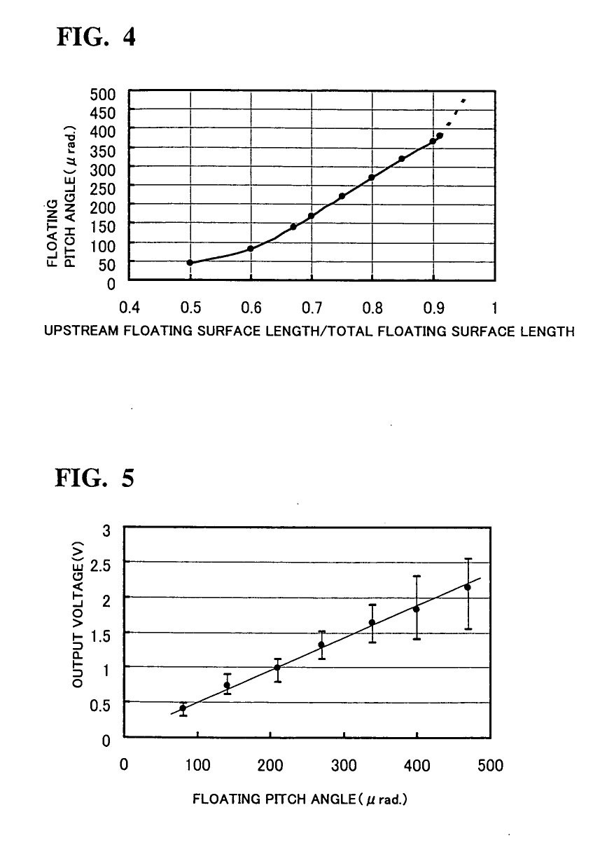

Some glide heads were prepared, in which the ratio of upstream floating surface length to total floating surface length was changed from 0.5 to 0.95 by changing the distance from the slider leading end to a load point with the glide head of EXAMPLE 1. By setting the force for a suspension arm to press the glide head to 37 mN and rotating a magnetic disk at a linear speed of 10 m/sec. relatively to the glide head, the floating pitch angle of each glide head was measured. A floating pitch angle was calculated from the ratio of the difference between a flying height of the sliding-rail leading end of each glide head and a flying height of the sliding-rail rear edge of each glide head to the total floating surface length. FIG. 4 shows a relationship between the floating pitch angle (μrad.) obtained here and the ratio of the upstream floating surface length to the total floating surface length by a graph. By changing positions of the load point, the floating pitch angle can be changed approx. from 50 μrad. to 470 μrad. However, when the upstream floating surface length/total floating surface length exceeds 0.91, the floating pitch angle exceeds 380 μrad., but the floating pitch angle becomes unstable.

Influence of Floating Pitch Angle on Output Voltage

For the glide head of EXAMPLE 1, seven groups of glide heads having floating pitch angles from 80 μrad. to 470 μrad. at an interval of 70 μrad. were prepared. Each group was constituted of five glide heads. Average values of floating pitch angles of the groups were 80, 140, 210, 270, 340, 400 and 470 μrad., and floating pitch angles in the groups were distributed within ±5 μrad. from the average values. By changing loads with the glide heads, flying heights of the glide heads from a bump disk were adjusted so that they became 10±0.2 nm. The alumina protrusions (defects) formed on the bump disk used were of a cylinder having a diameter of 1 μm and a height of 11 nm. The output voltage of a piezoelectric element transducer was measured for each glide head. FIG. 5 shows a graph showing output voltages (V) for floating pitch angles (μrad.). The graph of the output voltage in FIG. 5 is plotted with the average value of output voltages of glide head groups respectively having a floating pitch angle and also shows a range between the maximum value and the minimum value of the output voltages for each floating pitch angle. The output voltages measured here were obtained by amplifying output voltages from the piezoelectric element to 500 times by an amplifier. As the floating pitch angle increased, output voltages almost linearly increased and the average output voltage at 470 μrad. became approx. five times of the output voltage at a floating pitch angle of 80 μrad. As the floating pitch angle increased, the fluctuation of output voltages between five glide heads in each group increased. Therefore, it is preferable that the floating pitch angle is less than 400 μrad. and a floating pitch angle of 380 μrad. or less is more preferable. When the floating pitch angle became 140 μrad. or more, an output voltage approx. twice or more of the output voltage at a floating pitch angle of 80 μrad. of a conventional glide head was obtained.

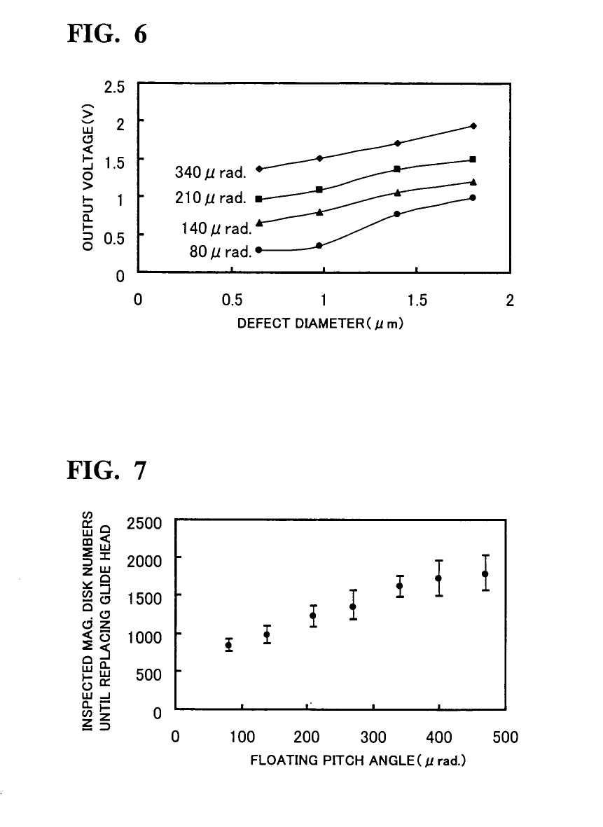

Among the glide heads prepared above, glide heads having floating pitch angles of 80, 140, 210 and 340 μrad. were used to measure output voltages by using a bump disk having defects of various diameters. The defects of alumina formed on the bump disk were of cylinders having a height of 11 nm and diameters of 0.65, 0.98, 1.4 and 1.8 μm. The four types of defects having the various diameters were formed at the same radius position of a bump disk to measure output voltages from the defects having the various diameters without replacing the bump disk. FIG. 6 shows average output voltages of the five glide heads with the respective floating pitch angle of 80, 140, 210 and 340 μrad. as parameters in the relation with diameters of defects.

As the diameter of a defect increased, an output voltage increased. With a conventional glide head having a floating pitch angle of 80 μrad., a change of output voltages was steep around a defect of a diameter of approx. 1 μm. With glide heads having floating pitch angles of 140 μrad. or more, an output voltage was almost linearly increased as the diameter of a defect increased. From the glide heads having floating pitch angles of 140 μrad. or more, large output voltages were obtained even when the diameter of a defect was 1 μm or less and it is found that sensitivity was more increased than ever.

Relationship Between Glide-Head Service Life and Floating Pitch Angle

By using the glide head groups prepared above having the floating pitch angles of 80, 140, 210, 270, 340, 400 and 470 μrad., magnetic disks were inspected, and the service lives of the glide heads were examined by number of magnetic disks which were able to be inspected until replacement of glide heads was required. When the output voltage of a glide head was lowered to 0.5 V or lower, it was judged that the service life of the glide head expired. FIG. 7 shows the result and a relationship between the number of inspected magnetic disks which can be inspected until replacement of glide heads and a floating pitch angle. The average service life of five glide heads for each group is plotted on the graph and the distribution of service lives of the five glide heads are also shown. As a floating pitch angle was increased, the number of magnetic disks that can be inspected until replacement of glide heads was increased, a glide head with a floating pitch angle of 140 μrad. or more was able to inspect 1.2 times to twice number of magnetic disks that a conventional one of a floating pitch angle of 80 μrad. could inspect, and it is found that a longer service life is realized.

### EXAMPLE 2

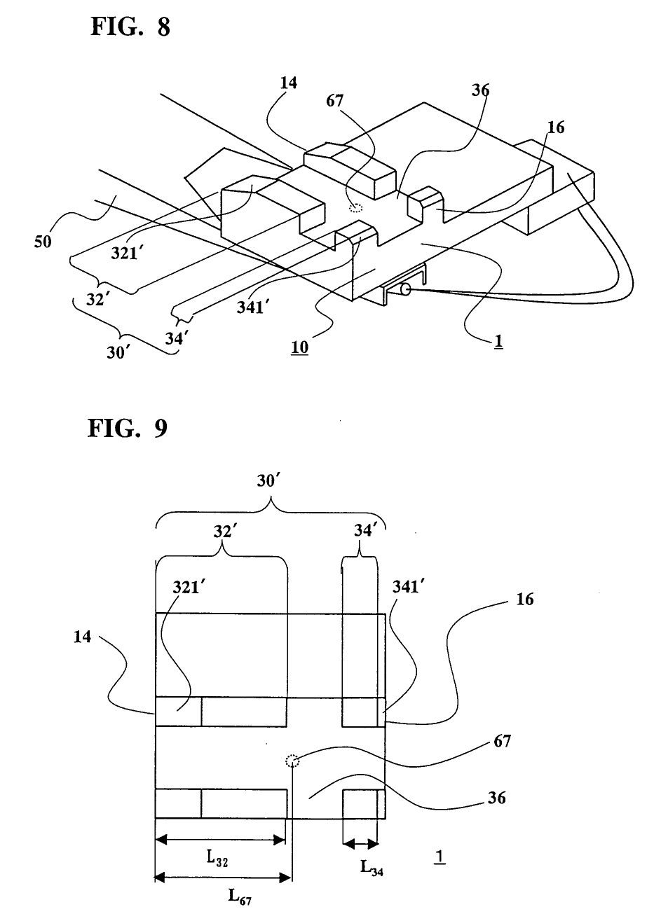

A glide head of EXAMPLE 2 of the present invention, observed from a bottom, is shown by a perspective view in FIG. 8 and a bottom plan view in FIG. 9. Because the glide head of EXAMPLE 2 is different from the glide head of EXAMPLE 1 in a structure of a sliding rail, the sliding rail is described below. Also in this EXAMPLE, a point on a bottom surface of the slider corresponding to the load point, at which a pressing force from the suspension arm 50 is applied to the slider 10, is referred to as “load point” 67 for convenience' sake and the load point 67 is substantially located on the center line between two sliding rails 30′. The sliding rails 30′ are divided by a groove 36 formed in a breadth wise direction of the slider, on which an upstream floating surface 32′ within a region from the slider leading end 14 to the load point 67 and a downstream floating surface 34′ within a region from the load point 67 to the slider trailing end 16 are formed. The load point 67 is positioned in the center of the slider length (1.25 mm), that is, a position at a distance of L₆₇: 0.625 mm from the leading end. The upstream floating surface 32′ has a tapered surface 321′ having an angle of 0.3 to 1.0° from the floating surface at its leading end. The length L₃₂ of the upstream floating surface 32′ is 0.6 mm, including the length 0.2 mm of the tapered surface 321′. The width of the traversing groove 36, that is, the length of the groove in the longitudinal direction of the sliding rail is 0.45 mm. Moreover, chamfering portion 341′ at the rear edge of the rail is not included in the downstream floating surface 34′ because it has a large angle of approx. 20°, and it does not contribute to a lifting power. Therefore, the length L₃₄ of the downstream floating surface 34′ is 0.16 mm. In this glide head, the ratio of the length L₃₂ of the upstream floating surface 32′ to the total floating surface length (L₃₂+L₃₄) is approx. 0.79. When rotating a magnetic disk at a linear speed of 10 m/sec. relatively to a glide head with a pressing force of 25 mN from a suspension arm to a slider, the flying height of the glide head was approx. 10 nm at the height of the rear edge of a sliding rail, and a floating pitch angle was approx. 295 μrad.

It is describe above that “the load point 67 is substantially located on the center line between the sliding rails 30′”. When the load point 67 is located within 1/10 of the slider width from the center line, the roll angle of a glide head can be maintained within ±10 μrad. Moreover, although it has been described that the load point 67 of the glide head of EXAMPLE 2 is substantially located on the center line and in the center between the leading end and trailing end of the slider, the load point 67 may be substantially located on the center line and between a position the downstream floating surface length ahead of a rear end of the upstream floating surface and a position a half of the groove width backward from the rear end of the upstream floating surface.

Influence of Ratio of Upstream Floating Surface Length to Total Floating Surface Length on Floating Pitch Angle

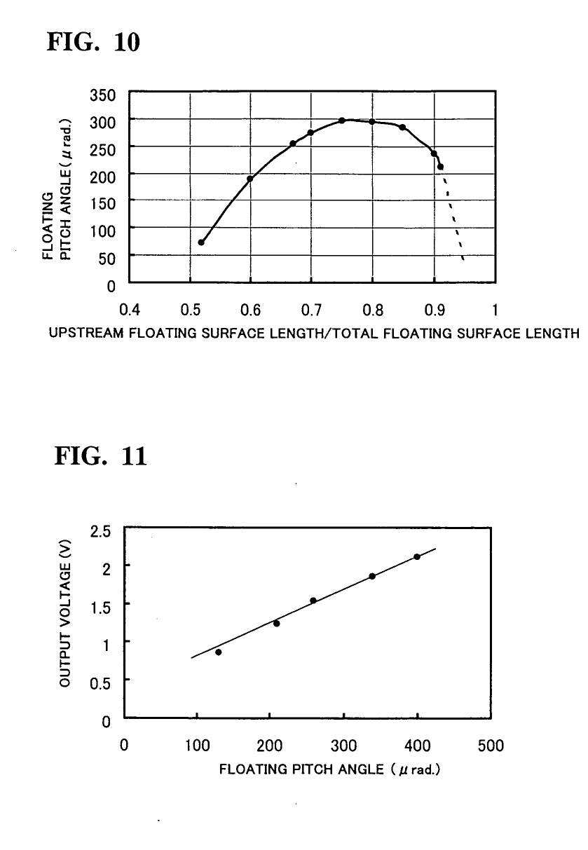

By changing the width of the traversing groove (length in the longitudinal direction of the sliding rail) with the glide heads of EXAMPLE 2, glide heads, in which the ratio of the upstream floating surface length to the total floating surface length was changed from 0.52 to 0.95, were prepared. By assuming a force for a suspension arm to press a glide head as 25 mN and rotating a magnetic disk at a linear speed of 10 m/sec. relatively to the glide head, the floating pitch angle of each glide head was measured. The floating pitch angles (μrad.) obtained here are shown in a graph of FIG. 10 in a relationship with the ratio of the upstream floating surface length to the total floating surface length. By changing widths of the grooves, a floating pitch angle can be changed from approx. 70 μrad. to approx. 295 μrad. When upstream floating surface length/total floating surface length is less than 0.67 or exceeds 0.91, the gradient of a curve is steep and a floating pitch angle is rapidly changed with a slight change of upstream floating surface length/total floating surface length. Moreover, when upstream floating surface length/total floating surface length exceeds 0.91, this is not preferable because a floating pitch angle becomes unstable. When upstream floating surface length/total floating surface length ranges between 0.67 and 0.91, a large floating pitch angle can be obtained and its change is small. It is more preferable that upstream floating surface length/total floating surface length ranges between 0.75 and 0.85, because a floating pitch angle is particularly stable with the change of upstream floating surface length/total floating surface length.

Influence of Floating Pitch Angle on Output Voltage

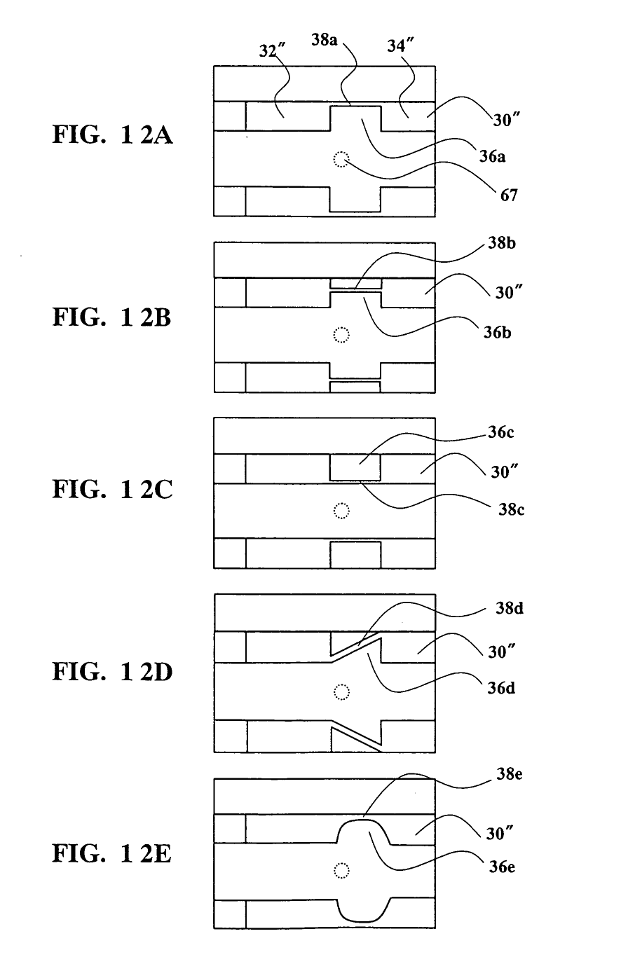

In the glide heads of EXAMPLE 2, five groups of glide heads respectively having various floating pitch angles between 130 μrad. and 400 μrad. were prepared. Each group was constituted of five glide heads. Average values of floating pitch angles for each group were 130, 210, 260, 340 and 400 μrad., and floating pitch angles in each group were distributed within ±5 μrad. By changing loads of a glide head, the flying height of the glide head from a bump disk was adjusted so that it became 10±0.2 nm. The alumina protrusions (defects) formed on the bump disk used were of cylinders having a diameter of 1 μm and a height of 11 nm. The output voltage of a piezoelectric element transducer was measured for each glide head, and FIG. 11 shows a graph showing an output voltage (V) for a floating pitch angle (μrad.). The graph of the output voltages in FIG. 11 is plotted by the average value of output voltages of glide head groups respectively having a floating pitch angle. The output voltages measured here were obtained by amplifying output voltages from a piezoelectric element to 500 times by an amplifier. As a result of comparing the output voltages in FIG. 11 with the output voltages in FIG. 5, the output voltages in FIG. 11 is approx. 1.5 times higher than the output voltages in FIG. 5. This is because the position of the load point was fixed in the glide head of EXAMPLE 2 though the floating pitch angle was increased by changing the position of the load point in EXAMPLE 1. Therefore, the distance from the load point to a portion for detecting a disk defect at the rear edge of the sliding rail is larger than that of the glide head of EXAMPLE 1, and the rotation torque due to the defect can be further increased. Therefore, it is considered that the sensitivity can be improved, since output voltages were further raised.

### EXAMPLE 3

Glide heads of EXAMPLE 3 of the present invention are shown by bottom views in FIGS. 12A to 12E. Because the glide heads of EXAMPLE 3 are different from that of EXAMPLE 2 in structure of a sliding rail, the sliding rails are described below. In the glide head shown in FIG. 12A, two sliding rails 30″ are longitudinally divided by a traversing groove 36a into a upstream floating surface 32″ in a region from the leading end of a slider to the load point 67 and a downstream floating surface 34″ in a region from the load point 67 to the trailing end of the slider. However, there is a narrow portion left after cutting on a side of the groove 36a, and the upstream floating surface 32″ and the downstream floating surface 34″ are partially connected by the left thin bridging rail 38a. An upper surface of the bridging rail 38a works as a floating surface. When a width of the bridging rail is less than 20% of a width of the sliding rail 30″, a floating pitch angle is not greatly influenced. For example, under a condition that the floating pitch angle of the glide head of EXAMPLE 2 without a bridging rail is 295 μrad., a glide head having a bridging rail, in which the ratio of bridging rail width/sliding rail width is within a range of 5 and 10%, has a floating pitch angle decreased by a few μrad. from the glide head of EXAMPLE 2. In a glide head having a bridging rail with a width of 15% of a sliding rail width, a floating pitch angle is decreased by 30 to 50 μrad. from the glide head of EXAMPLE 2.

In the glide head shown in FIG. 12A, the bridging rails 38a are disposed along the outer sides of the sliding rails 30″. In a glide head of FIG. 12B, a bridging rail 38b is positioned in a center of the width of a sliding rail 30″, while a glide head shown in FIG. 12C has bridging rails 38c along inner sides of the sliding rails 30″. In a glide head of FIG. 12D, a bridging rail 38d is set so as to connect an outer side and an inner side of the siding rail 30″. In a glide head shown in FIG. 12E, a bridging rail 38e left after cutting a groove 36e forms a circular arc along an outer side of sliding rails 30″. The glide heads shown in FIGS. 12B to 12E respectively have the same function as that of the glide head in FIG. 12A. However, because the bridging rails 38a to 38e disposed in the both sliding rails 30″ keep roll angles of the glide heads small, it is desirable that the rails 38a to 38e are symmetric to each other with respect to the center line passing through the load point.

### EXAMPLE 4

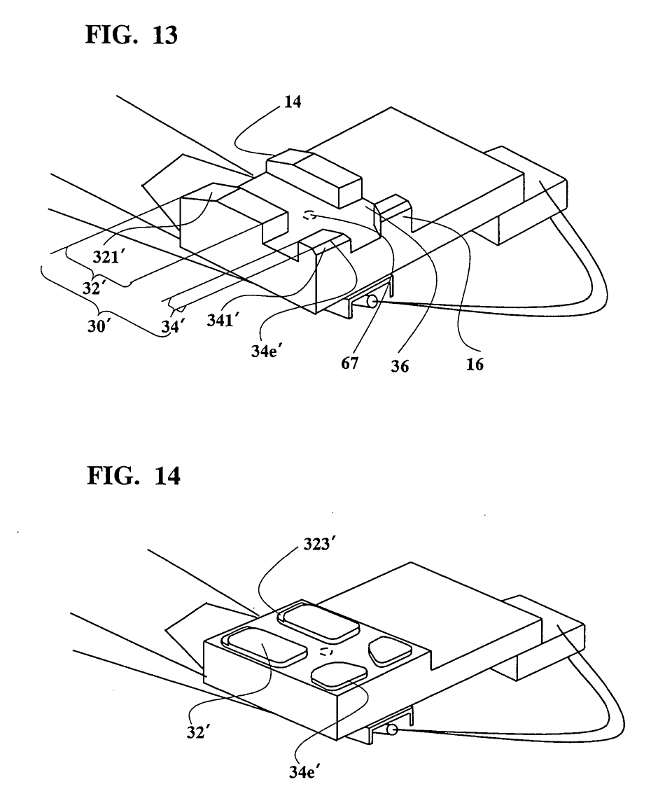

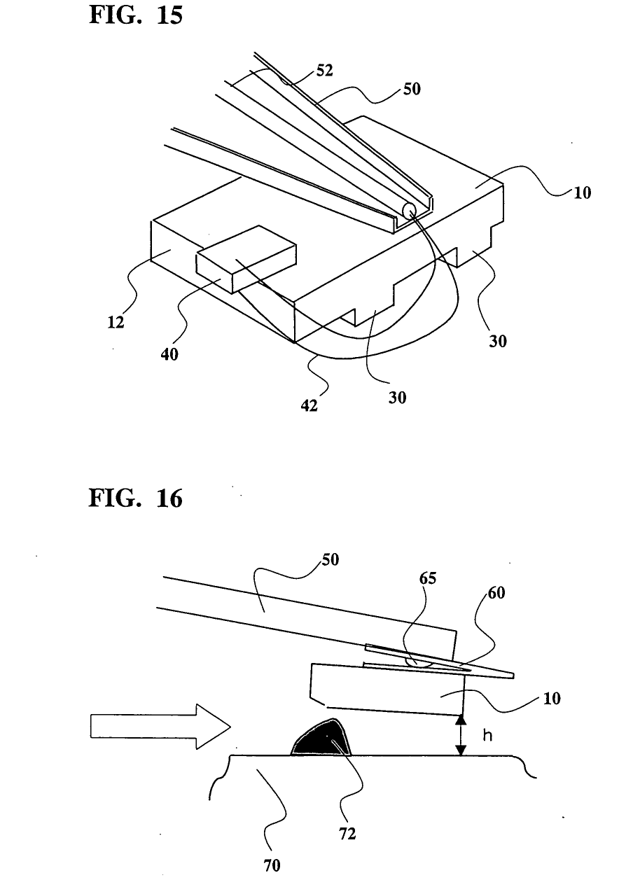

FIG. 13 shows a glide head of EXAMPLE 4 of the present invention by a perspective view observed from a bottom. Because the glide head of EXAMPLE 4 is different from that of EXAMPLE 2 in structure of a downstream floating surface 34′ of the sliding rail, the sliding rail 30′ is described below. Two sliding rails 30′ are divided by a traversing groove 36 into an upstream floating surface 32′ in a region from a slider leading end 14 to the load point 67 and a downstream floating surface 34′ within a region from the load point 67 to the slider trailing end 16. The sliding rails 30′ respectively have a tapered surface 321′, in which the upstream floating surface 32′ has an angle of 0.3 to 1.0° from a floating surface on their leading end. Chamfering portions 341′ disposed at rear edges of the rails have an angle of approx. 20°, but the angle does not contribute to lifting power. Therefore, the chamfering portion 341′ is not included in the downstream floating surface 34′. The rear edge 34e′ of the downstream floating surface 34′ is widened to approx. 130% of a width of the upstream floating surface 32′. However, because a width of a front end of the downstream floating surface is the same as the width of the upstream floating surface and the downstream floating surface is shorter than the upstream floating surface, a floating pitch angle is not greatly influenced even if the width of the rear edge of the downstream floating surface is widened. As a result of comparing the glide head of EXAMPLE 4 with that of EXAMPLE 2, there was not any large difference in floating pitch angle between them. However, in the glide head of EXAMPLE 4 having a broadened rear edge width of the downstream floating surface, the time required to inspect a bump disk was able to be reduced by 30%.

### EXAMPLE 5

FIG. 14 shows a glide head of EXAMPLE 5 of the present invention by a perspective view observed from a bottom. The glide head of EXAMPLE 5 is different from that of EXAMPLE 2 in structure of a front end of an upstream floating surface of a sliding rail. An inflow flattened surface 323′ lowered from a floating surface by 0.8 μm is formed at a distance of 0.08 mm from the front end of the upstream floating surface. Moreover, a width of a rear edge 34e′ of a downstream floating surface is approx. 160% of a width of the upstream floating surface. The inflow flattened surface 323′ works as part of the upstream floating surface 32′, and the inflow flattened surface 323′ can be treated as part of the upstream floating surface 32′. In the glide head, a floating pitch angle almost equal to that of the glide head of EXAMPLE 2 was accomplished. Moreover, because the rear edge 34e′ of the downstream floating surface is broadened, the time required to inspect a magnetic disk was able to be shortened by approx. 40%.

### INDUSTRIAL APPLICABILITY

The invention can accomplish an improvement in sensitivity of a glide head for detecting defects of a magnetic disk in use for a hard disk drive and prolongation of a service life of the glide head. Because of the trends of the increase in capacity of a hard disk drive and the miniaturization of it, a magnetic head slider is required to have a flying height less than 12 nm, and by the requirement a glide head of a high sensitivity is necessitated to detect a magnetic disk defect less than 9 nm. Accompanying that, a glide head of a long service life is required to develop the efficiency in a magnetic disk inspection. The glide head of the invention matches these requirements.

1. A glide head for a magnetic disk, comprising:
a suspension arm and
a slider, whose back is resiliently held to an end of the suspension arm through a flexure and has a load point to which a pressing force from the suspension arm is applied through a pivot disposed on the flexure;
the slider comprising, on a bottom surface of the slider opposed to the back, two sliding rails protruding from the bottom surface, extending from a leading end of the slider to a trailing end of the slider, in parallel and at a distance from each other, and having, near the trailing end of the slider, a rear edge that works as a sensor for encountering a defect on a magnetic disk;
a transducer for transforming a mechanical energy caused due to the defect to an electric signal mounted on the back; and
the load point positioned substantially on a center line between the two sliding rails on the back;
wherein each of the two sliding rails has an upstream floating surface positioned within a region from the slider leading end to the load point and a downstream floating surface positioned within a region from the load point to the slider trailing end on a floating surface of the sliding rail so that the slider has a floating pitch angle from 140 to 380 μrad.

2. A glide head for a magnetic disk as set forth in claim 1, wherein a length of the upstream floating surface of each of the sliding rails is from 0.67 to 0.91 when expressed by a ratio to the sum of the length of the upstream floating surface plus a length of the downstream floating surface.

3. A glide head for a magnetic disk as set forth in claim 2, wherein the upstream floating surface continues to the downstream floating surface.

4. A glide head for a magnetic disk as set forth in claim 2, wherein each of the two sliding rails is divided into the upstream floating surface and the downstream floating surface by a traversing groove disposed on the sliding rails.

5. A glide head for a magnetic disk as set forth in claim 1, wherein the upstream floating surface has a tapered surface having an angle from 0.3 to 1.0 degrees with respect to the floating surface at the leading end.

6. A glide head for a magnetic disk as set forth in claim 1, wherein the downstream floating surface is widening in a direction of the rear edge of the sliding rail, and the total width of the two sliding rails at the rear edges is equal to or more than a half of a distance between outside surfaces of the two sliding rails.

7. A glide head for a magnetic disk as set forth in claim 1, wherein the floating pitch angle is measured under conditions that:
a relative linear speed of the glide head is 8 to 16 m/sec.;
a flying height of the glide head is 1 to 15 nm; and
the pressing force of the suspension arm is 9.8 to 58.8 mN.
